(19) United States
(12) Patent Application Publication
(10) Pub. No.: US 2010/0002181 A1
(43) Pub. Date: Jan. 7, 2010

(54) DISPLAY DEVICE

(76) Inventors: Ryujiro Takamatsu, Ishikawa-gun (JP); Iwane Ichiyama, Nomi-gun (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/496,459

(22) Filed: Jul. 1, 2009

(30) Foreign Application Priority Data
Jul. 7, 2008 (JP) 2008-177387

(51) Int. Cl. G02F 1/1345

(52) U.S. Cl. 349/149

(57) ABSTRACT

A display device includes a display panel including a display section which is composed of a plurality of display pixels, a driving module for driving the plurality of display pixels, and a driving signal source which supplies control signals to the display panel and is attached to the display panel by a connection module. The connection module includes a first connection region which is electrically connected to the display panel, a second connection region which is electrically connected to the driving signal source, connection wiring lines which connect first pins disposed in the first connection region and second pins disposed in the second connection region, and are supplied with the control signals of the display panel, and dummy wiring lines which connect third pins disposed in the first connection region and fourth pins disposed in the second connection regions.

### CROSS-REFERENCE TO RELATED APPLICATIONS

This application is based upon and claims the benefit of priority from prior Japanese Patent Application No. 2008-177387, filed Jul. 7, 2008, the entire contents of which are incorporated herein by reference.

### BACKGROUND OF THE INVENTION

1. Field of the Invention

The present invention relates generally to a display device, and more particular to an active matrix display device.

2. Description of the Related Art

A liquid crystal display device, as an example of the display device, comprises a liquid crystal display panel including a display section which is composed of a plurality of display pixels, driving means for driving the plural display pixels, and a driving signal supply source which supplies driving signals and power supply voltage signals to the driving means.

The liquid crystal display panel comprises an array substrate and a counter-substrate which are opposed to each other, and a liquid crystal layer which is held between the array substrate and the counter-substrate, and includes a display section which is composed of matrix-arrayed display pixels. In the display section, there are disposed scanning lines which are arranged along the row direction of the array of display pixels, and signal lines which are arranged along the column direction of the array of display pixels. Driving signal sources, such as driving ICs for supplying driving signals to the display section and flexible wiring boards, are mounted on an outer peripheral part of the display section.

There has conventionally been proposed a technique in which when a semiconductor element, such as an IC chip or an LSI chip, which has bumps that are projecting electrodes, is to be mounted on a semiconductor mounting board, an anisotropic conductive film is coated on this mounting board, following which the IC chip, for instance, is disposed at a predetermined position and is mounted by heating and pressing (see Jpn. Pat. Appln. KOKAI Publication No. 2004-214373).

The above-described mounting board is advantageous in reducing the board size or the thickness of modules, and in some cases this mounting board is used in display devices.

When a mounting board (e.g. TAB (Tape Automated Bonding)) on which the above-described IC chip, or the like, is mounted, is to be connected to a liquid crystal display panel and an external board, the connection terminals of the liquid crystal display panel and external substrate are aligned with the connection terminals of the mounting board and then the mounting board is connected to the liquid crystal display panel and external board by heating and pressing.

In the case where the width of the board, which is used for the mounting board, in the direction of arrangement of their connection terminals, is fixed, there is a case in which the number of wiring lines for inputting control signals, etc., to the mounted IC chip, etc., is less than the number of connection terminals. In this case, of the connection terminals of the mounting board, there occur connection terminals which are used for connection of the wiring lines to which control signals, etc. are input, and connection terminals which are not used.

In particular, compared to a source driver, a gate driver that drives gate lines has a less number of wiring lines to which control signals are input. Thus, in some cases, the mounting board, on which the gate driver is mounted, may have some terminals to which control signals, etc., are not supplied.

In such cases, if the connection terminals, to which the wiring lines for supplying signals to the IC chip or the like are connected, and the connection terminals, to which such wiring lines are not connected, are heated at the same time, the temperature of the part where the IC chip or the like is disposed and the temperature of the other part become non-uniform since the heat radiation properties are different between these connection terminals. Consequently, lifting or peeling occurs at pressure-bonded parts of the mounting board, leading to defective pressure-bonding.

### BRIEF SUMMARY OF THE INVENTION

The present invention has been made in consideration of the above-described problems, and the object of the invention is to provide a display device in which lifting or peeling of a pressure-bonded part is prevented, and a decrease in manufacturing yield due to defective mounting is improved.

According to a first aspect of the present invention, there is provided a display device comprising: a display panel including a display section which is composed of a plurality of display pixels; driving means for driving the plurality of display pixels; and a driving signal source which supplies control signals to the display panel and is attached to the display panel by connection means including: first pins disposed in a first connection region which is electrically connected to the display panel, second pins disposed in a second connection region which is electrically connected to the driving signal source, connection wiring lines which connect the first pins and the second pins and are supplied with the control signals of the display panel from the driving signal source, third pins disposed in the first connection region, fourth pins disposed in the second connection regions; and dummy wiring lines which connect the third pins and the fourth pins.

According to a second aspect of the present invention, there is provided a display device comprising: a display panel including a display section which is composed of a plurality of display pixels; driving means for driving the plurality of display pixels; and a driving signal source which supplies control signals to the display panel and is attached to the display panel by connection means including: a first connection region which is electrically connected to the display panel, first pins disposed at first predetermined intervals in the first connection region, a second connection region which is electrically connected to the driving signal source, second pins disposed at second predetermined intervals in the second connection region, connection wiring lines which connect the first pins and the second pins and are supplied with the control signals of the display panel from the driving signal source, third pins are disposed between the first pins; and fourth pins are disposed between the second pins.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 schematically shows a structure example of a display device according to an embodiment of the present invention;

FIG. 2 schematically shows a first structure example of a driving board of the display device shown in FIG. 1;

FIG. 3 schematically shows a second structure example of the driving board of the display device shown in FIG. 1; and

FIG. 4 schematically shows a third structure example of the driving board of the display device shown in FIG. 1.

### DETAILED DESCRIPTION OF THE INVENTION

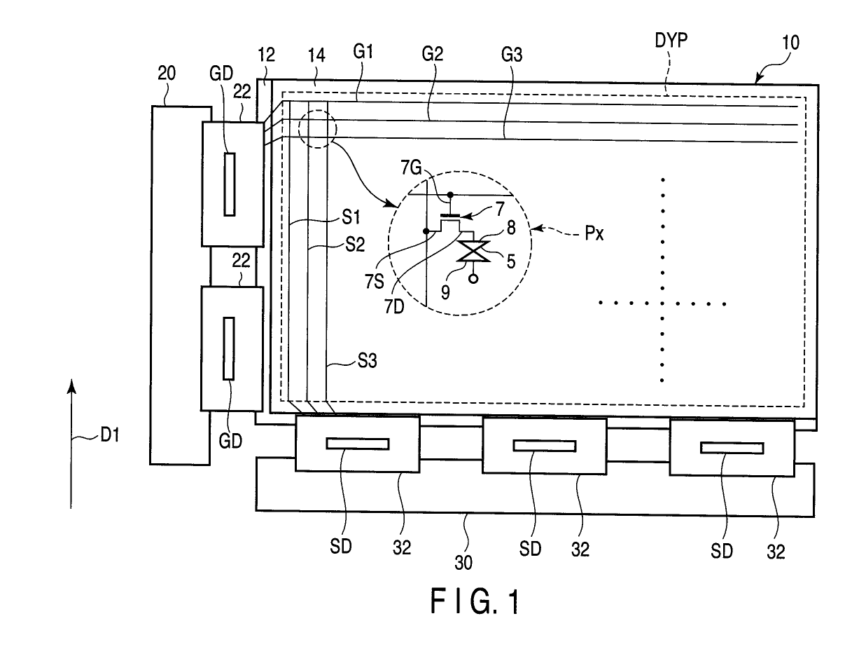

A display device according to a first embodiment of the present invention will now be described with reference to the accompanying drawings. As shown in FIG. 1, the display device according to this embodiment is a liquid crystal display device which includes a liquid crystal display panel 10 having a display section DYP that is composed of a plurality of matrix-arrayed display pixels PX.

The liquid crystal display panel 10 includes an array substrate 12, a counter-substrate 14 which is disposed to be opposed to the array substrate 12, and a liquid crystal layer 5 which is held between the array substrate 12 and the counter-substrate 14. The array substrate 12 includes pixel electrodes 8 which are disposed in association with the respective display pixels PX. The counter-substrate 14 includes a counter-electrode 9 which is disposed to be opposed to the plural pixel electrodes 8.

In the display section DYP of the liquid crystal display panel, there are arranged a plurality of scanning lines G (G1, G2, G3, . . . ) which are arranged along the rows of the arrayed display pixels PX, and a plurality of signal lines S (S1, S2, S3, . . . ) which are arranged along the columns of the arrayed display pixels PX.

Pixel switches 7, which switch the connection between the signal lines S and pixel electrodes 8, are disposed near intersections between the scanning lines G and signal lines S in the respective display pixels PX. Each pixel switch 7 includes, for example, a thin-film transistor as a switching element.

A gate electrode 7G of the pixel switch 7 is electrically connected to the associated scanning line G (or formed integral with the associated scanning line G). A source electrode 7S of the pixel switch 7 is electrically connected to the associated source line S (or formed integral with the associated source line S). A drain electrode 7D of the pixel switch 7 is electrically connected to the associated pixel electrode 8 (or formed integral with the associated pixel electrode 8).

If a predetermined ON-voltage is applied to the gate electrode 7G of the pixel switch 7, the source-drain path is rendered conductive, and a voltage signal, which is applied to the associated source line S, is supplied to the pixel electrode 8. A counter-voltage is supplied to the counter-electrode 9 by a counter-electrode driving circuit (not shown). The alignment state of liquid crystal molecules (not shown), which are included in the liquid crystal layer 5, is controlled by the potential difference between the voltage that is applied to the pixel electrode 8 and the voltage that is applied to the counter-electrode 9.

Driving boards 22 and 23, on which ICs for driving the display pixels PX are mounted, are connected to end portions of the array substrate 12. The driving board 22, 32 is, for instance, a TAB (Tape Automated Bonding) board (COF (Chip On Film)), or a TCP (Tape Carrier Package), and is a flexible board which is configured such that an IC chip or an LSI is mounted on a film.

A gate driver GD, which successively drives the scanning lines G, is mounted on the driving board 22. A source driver SD, which drives the signal lines S, is mounted on the driving board 32. A circuit board 20, which supplies control signals and power supply signals of the gate driver GD, is connected to that end portion of the driving board 22, which is opposite to the end portion thereof facing the liquid crystal display panel 10. A circuit board 30, which supplies control signals and power supply signals of the source driver SD, is connected to that end portion of the driving board 32, which is opposite to the end portion thereof facing the liquid crystal display panel 10.

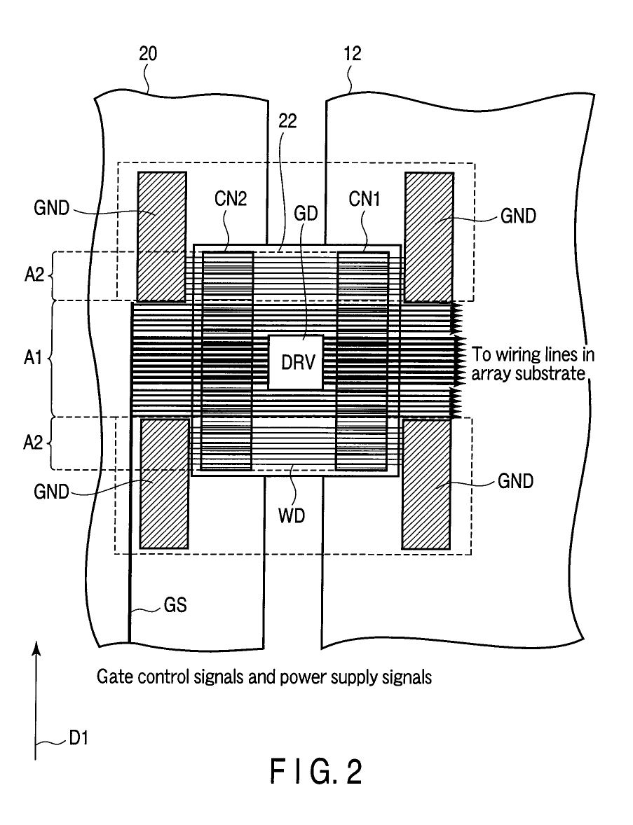

As shown in FIG. 2, the driving board 22 includes a first connection region CN1 which is connected to the array substrate 12, and a second connection region CN2 which is connected to the circuit board 20. The first connection region CN1 is electrically connected to the array substrate 12 via an anisotropic conductive film (ACF). The second connection region CN2 is electrically connected to the circuit board 20 via an anisotropic conductive film.

Each of the first connection region CN1 and second connection region CN2 includes a plurality of connection pins. In the liquid crystal display device according to the present embodiment, connection pins (second pins), which are disposed in a central part A1 in a direction D1 in which the connection pins of the second connection region CN2 are arranged, are connected to a wiring line GS through which the control signals or power supply signals are supplied to the gate driver GD. Connection pins (fourth pins), which are disposed in end parts A2 in the direction D1 of the second connection region CN2, are connected to a ground wiring line GND of the circuit board 20.

Connection pins (first pins), which are disposed in a central part A1 in the direction D1 of the first connection region CN1, are connected to wiring lines through which output signals from the gate driver GD are supplied, and to wiring lines through which power supply signals are supplied. Connection pins (third pins), which are disposed in end parts A2 in the direction D1 of the first connection region CN1, are connected to a ground wiring line GND of the array substrate 12.

Further, the driving board 22 includes dummy wiring lines WD which connect those (fourth pins) of the connection pins of the second connection region, which are connected to the ground wiring line GND of the circuit board 20, and those (third pins) of the connection pins of the first connection region, which are connected to the ground wiring line GND of the array substrate 12.

In the case shown in FIG. 2, the connection pins (third pins), which are disposed in the end parts A2 of the first connection region CN1, and the connection pins (fourth pins), which are disposed in the end parts A2 in the direction D1 of the second connection region CN2, are connected to the ground lines GND. Alternatively, these connection pins may be connected to floating wiring lines.

Specifically, of the connection pins of the first connection region CN1 and second connection region CN2 of the driving board 22, the connection pins, which are not used for the supply of control signals or power supply signals of the gate driver GD, are connected to the ground wiring lines GND and dummy wiring lines WD.

Thereby, the connection pins, which are used for the supply of control signals or power supply signals of the gate driver GD, and the connection pins, which are not used for the supply of control signals or power supply signals of the gate driver GD, have substantially equal heat radiation properties. Thereby, in the case where the first connection region CN1 and second connection region CN2 are heated, it becomes possible to avoid the occurrence of parts with high heat radiation properties and parts with low heat radiation properties.

For example, in the case where the above-described driving board 22 is connected to the array substrate 12, an anisotropic conductive film is attached to the first connection region CN1 of the driving board 22 or to the connection region of the array substrate 12. Next, the connection pins of the first connection region CN1 and the connection pins of the connection region of the array substrate 12 are aligned. In the state in which the first connection region CN1 of the driving board 22 and the connection region of the array substrate 12 are aligned, connection parts are heated at a predetermined temperature and pressed in the thickness direction of the array substrate 12. Thus, the driving board 22 is pressure-bonded to the array substrate 12.

In the display device according to the present embodiment, as described above, the connection pins, which are used for the supply of control signals or power supply signals of the gate driver GD, and the connection pins, which are not used for the supply of control signals or power supply signals of the gate driver GD, are configured to have substantially equal heat radiation properties. Thus, even in the case where the first connection region CN1 and second connection region CN2 of the driving board 22 are heated in a pressure-bonding step of the driving board 22, it becomes possible to prevent the connection pins from having different heat radiation properties between the central part A1 and end part A2 in the direction D1.

Therefore, the present embodiment can provide a display device in which lifting or peeling of a pressure-bonded part is prevented, and a decrease in manufacturing yield due to defective mounting is improved.

In the above description, the driving board 22 has been described. Similarly, the driving board 32 may be configured such that the connection pins, which are not used for the supply of control signals or power supply signals of the source driver SD, and the connection pins, which are used for the supply of control signals or power supply signals of the source driver SD, have substantially equal heat radiation properties. Thereby, defective pressure bonding due to lifting or peeling of the driving board 32 can be prevented.

Next, a display device according to a second embodiment of the present invention is described with reference to the accompanying drawings. In the description below, the structural parts common to those of the display device according to the above-described first embodiment are denoted by like reference numerals, and a description thereof is omitted.

The display device according to the present embodiment includes the liquid crystal display panel 10, like the display device of the above-described first embodiment. Driving boards 22 and 32 are connected to end portions of the array substrate 12 of the liquid crystal display panel 10.

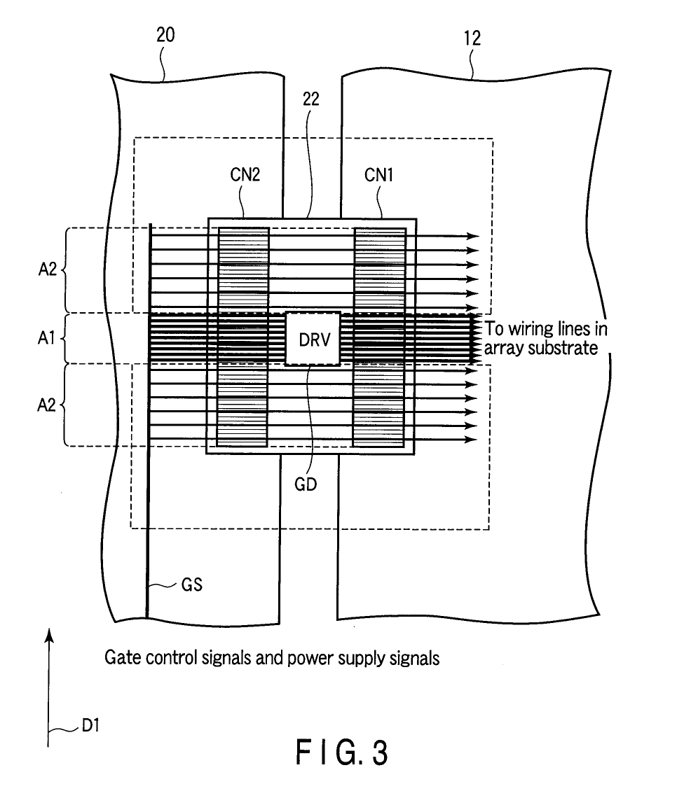

As shown in FIG. 3, the driving board 22 includes a first connection region CN1 and a second connection region CN2. The first connection region CN1 is electrically connected to the array substrate 12 via an anisotropic conductive film. The second connection region CN2 is electrically connected to the circuit board 20 via an anisotropic conductive film.

Each of the first connection region CN1 and second connection region CN2 includes a plurality of connection pins. In the liquid crystal display device according to the present embodiment, control signals, which are supplied from the wiring line GS to the gate driver GD, are delivered to connection pins which are disposed in the central part A1 in the direction D1 of the second connection region CN2. Connection pins (second pins), to which power supply signals are supplied from the wiring line GS, are disposed at predetermined intervals in the end part A2 in the direction D1 of the second connection region CN2.

In the end part A2 of the second connection region CN2, connection pins (fourth pins), to which neither driving signals nor power supply signals are supplied, are disposed between the connection pins to which power supply signals are supplied. It is desirable that the connection pins, to which power supply signals are supplied, be disposed over the end part A2 so as not to make non-uniform the intervals of the connection pins in the direction D1, and it is more desirable that these connection pins be disposed at equal intervals over the end part A2.

The connection pins, which are disposed in the central part A1 in the direction D1 of the first connection region CN1, are connected to wiring lines through which output signals from the gate driver GD that is connected to the wiring line GS are supplied. In the end part A2 in the direction D1 of the first connection region CN1, connection pins (first pins) that are connected to wiring lines, to which power supply signals are supplied, are disposed at predetermined intervals.

In the end part A2 of the first connection region CN1, connection pins (third pins), to which neither driving signals nor power supply signals are supplied, are disposed between the connection pins to which power supply signals are supplied. It is desirable that the connection pins, to which power supply signals are supplied, be disposed over the end part A2 so as not to make non-uniform the intervals of the connection pins in the direction D1, and it is more desirable that these connection pins be disposed at equal intervals over the end part A2.

Specifically, the connection pins, to which power supply signals are supplied, are disposed at predetermined intervals in the end parts A2 of the first connection region CN1 and second connection region CN2 of the driving board 22. Thereby, in the case where the first connection region CN1 and second connection region CN2 are heated, it becomes possible to avoid the occurrence of parts with high heat radiation properties and parts with low heat radiation properties.

Therefore, the present embodiment, like the above-described first embodiment, can provide a display device in which lifting or peeling of a pressure-bonded part is prevented, and a decrease in manufacturing yield due to defective mounting is improved.

Like the case of the display device according to the first embodiment, the above-described structure of the driving board 22 is also applicable to the driving board 32.

Next, a display device according to a third embodiment of the present invention is described with reference to the accompanying drawings. The display device according to the present embodiment includes the liquid crystal display panel 10, like the display device of the above-described first embodiment. Driving boards 22 and 32 are connected to end portions of the array substrate 12 of the liquid crystal display panel 10.

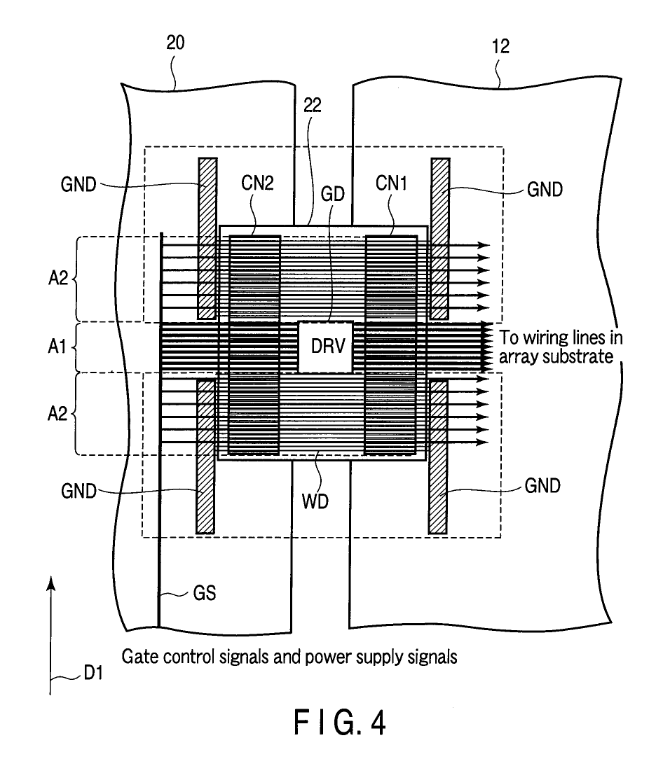

As shown in FIG. 4, the driving board 22 includes a first connection region CN1 and a second connection region CN2. The first connection region CN1 is electrically connected to the array substrate 12 via an anisotropic conductive film. The second connection region CN2 is electrically connected to the circuit board 20 via an anisotropic conductive film.

Each of the first connection region CN1 and second connection region CN2 includes a plurality of connection pins. In the liquid crystal display device according to the present embodiment, control signals, which are supplied from the wiring line GS to the gate driver GD, are delivered to connection pins which are disposed in the central part A1 in the direction D1 of the second connection region CN2. Connection pins (second pins), to which power supply signals are supplied from the wiring line GS, are disposed at predetermined intervals in the end part A2 in the direction D1 of the second connection region CN2.

In the end part A2 of the second connection region CN2, connection pins (fourth pins), which are connected to a ground wiring line GND of the circuit board 20, are disposed between the connection pins (second pins) to which power supply signals are supplied. It is desirable that the connection pins, to which power supply signals are supplied, be disposed over the end part A2 so as not to make non-uniform the intervals of the connection pins in the direction D1, and it is more desirable that these connection pins be disposed at equal intervals over the end part A2.

The connection pins, which are disposed in the central part A1 in the direction D1 of the first connection region CN1, are connected to wiring lines through which output signals from the gate driver GD that is connected to the wiring line GS are supplied. In the end part A2 in the direction D1 of the first connection region CN1, connection pins (first pins), to which power supply signals are supplied, are disposed at predetermined intervals.

In the end part A2 of the first connection region CN1, connection pins (third pins), which are connected to a ground wiring line GND of the array substrate 12, are disposed between the connection pins (first pins) to which power supply signals are supplied. It is desirable that the connection pins, to which power supply signals are supplied, be disposed over the end part A2 so as not to make non-uniform the intervals of the connection pins in the direction D1, and it is more desirable that these connection pins be disposed at equal intervals over the end part A2.

Further, the driving board 22 includes dummy wiring lines WD which connect the connection pins (fourth pins), which are connected to the ground wiring line GND disposed in the end part A2 of the second connection region CN2, and the connection pins (third pins), which are connected to the ground wiring line GND disposed in the end part A2 of the first connection region CN1.

Specifically, in the present embodiment, the connection pins, to which power supply signals are supplied, are disposed at predetermined intervals in the end parts A2 of the first connection region CN1 and second connection region CN2 of the driving board 22.

Furthermore, of the connection pins of the first connection region CN1 and second connection region CN2 of the driving board 22, the connection pins, which are not used for the supply of control signals or power supply signals of the gate driver GD, are connected to the ground wiring lines GND and dummy wiring lines WD.

Thereby, in the case where the first connection region CN1 and second connection region CN2 are heated, it becomes possible to avoid the occurrence of parts with high heat radiation properties and parts with low heat radiation properties.

Therefore, the present embodiment, like the above-described first embodiment, can provide a display device in which lifting or peeling of a pressure-bonded part is prevented, and a decrease in manufacturing yield due to defective mounting is improved.

The present invention is not limited directly to the above-described embodiments. In practice, the structural elements can be modified and embodied without departing from the spirit of the invention. For example, in the above-described embodiments, the liquid crystal display device has been described as the display device. The invention, however, is applicable to display devices, other than the liquid crystal display device, if a circuit board is connected to a display panel by heating and pressing a connection board such as a TAB. In this case, too, the same advantageous effects as in the above-described embodiments can be obtained.

Various inventions can be made by properly combining the structural elements disclosed in the embodiments. For example, some structural elements may be omitted from all the structural elements disclosed in the embodiments. Furthermore, structural elements in different embodiments may properly be combined.

What is claimed is:

1. A display device comprising:
a display panel including a display section which is composed of a plurality of display pixels;
driving means for driving the plurality of display pixels; and
a driving signal source which supplies control signals to the display panel and is attached to the display panel by connection means including:
a first connection region which is electrically connected to the display panel,
first pins disposed in the first connection region,
a second connection region which is electrically connected to the driving signal source,
second pins disposed in the second connection region,
connection wiring lines which connect the first pins and the second pins and are supplied with the control signals of the display panel from the driving signal source,
third pins disposed in the first connection region,
fourth pins disposed in the second connection regions; and
dummy wiring lines which connect the third pins and the fourth pins.

2. The display device according to claim 1, wherein the dummy wiring lines are electrically connected to ground electrodes of the display panel and the driving signal source, or to floating electrodes, via the third pins and the fourth pins.

3. A display device comprising:
a display panel including a display section which is composed of a plurality of display pixels;
driving means for driving the plurality of display pixels; and
a driving signal source which supplies control signals to the display panel and is attached to the display panel by connection means including:
a first connection region which is electrically connected to the display panel,
first pins disposed at first predetermined intervals in the first connection region,
a second connection region which is electrically connected to the driving signal source,
second pins disposed at second predetermined intervals in the second connection region,
connection wiring lines which connect the first pins and the second pins and are supplied with the control signals of the display panel from the driving signal source,
third pins are disposed between the first pins; and
fourth pins are disposed between the second pins.

4. The display device according to claim 3, wherein the connection means further includes dummy wiring lines which connect the third pins disposed in the first connection region and the fourth pins disposed in the second connection region, and
the dummy wiring lines are connected to ground electrodes of the display panel and the driving signal source, or to floating electrodes, via the third pins and the fourth pins.

5. The display device according to any one of claims 1 to 4, wherein the driving means includes first driving means for driving the plurality of display pixels on a row-by-row basis, and second driving means for supplying video signals to those of the plurality of display pixels, which are selected by the first driving means, and
the first driving means is disposed in the connection means.
